(19) United States
(12) Patent Application Publication
(10) Pub. No.: US 2016/0153204 A1
(43) Pub. Date: Jun. 2, 2016

(54) System and Method for Cladding Walls using Plastic Panels and Adapters for Use with Standard Power Saws

(71) Applicants: Arie CASPI, Ramot Hashavim (IL); Eliezer GOLDSTEIN, Kiryat Tivon (IL)

(72) Inventors: Arie CASPI, Ramot Hashavim (IL); Eliezer GOLDSTEIN, Kiryat Tivon (IL)

(21) Appl. No.: 14/904,082

(22) PCT Filed: Jul. 13, 2014
(86) PCT No.: PCT/IL2014/000034

§ 371 Date: Jan. 9, 2016

(30) Foreign Application Priority Data
Jul. 11, 2013 (IL) 227435

(51) Int. Cl. E04F 21/00; B23D 45/00; B23D 47/02; E04F 13/076; E04F 13/18

(52) U.S. Cl. CPC E04F 21/00; E04F 13/076; E04F 13/18; B23D 47/02; B23D 45/003

(57) ABSTRACT

A method and system for cladding of walls using plastic panels that includes a connector shaped like long and narrow strip. The method for cladding and joining the plastic panels to one another includes the following steps: a narrow groove is executed in the longitudinal sides of the plastic panels; one plastic panel is applied to the wall using adhesive; the connector is inserted into the groove of the already applied plastic panel and into the groove of another plastic panel, so that they are tightly joined by the connector; before or after the plastic panels are joined, adhesive is applied to the connector and/or in the grooves. Special adaptors designed to help execute relatively deep and narrow grooves in the longitudinal sides of the plastic panels used for cladding using a vertical or horizontal standard power saw.

### TECHNICAL FIELD

The present invention refers to a method and system for cladding of walls using plastic panels and to unique adapters for designed for use with standard, vertical and horizontal power saws or mills (hereinafter referred to as “power saws”) used to execute relatively deep and narrow longitudinal grooves in the longitudinal sides of the said plastic panels.

### BACKGROUND ART

After performing medical procedures and surgeries, it is customary to thoroughly rinse off and clean the operating room walls to remove any dirt that might harbor and facilitate the accumulation and multiplication of bacteria. The walls of laboratories and other rooms in which pharmaceuticals or food are manufactured are similarly rinsed and cleaned for the same reason. Such rooms, whose cleanliness is important, will be referred to hereafter as “sterile rooms”. Certain institutions have standards that require the walls of sterile rooms to be smooth and washable. A great deal of interest is currently being expressed in cladding sterile room walls with plastic panels that can be rinsed and cleaned quickly, efficiently, and at relatively low cost. Plastic panels designed for cladding of sterile room walls are commonly approximately 300 cm high, 150 cm wide, and 2 mm thick and they are usually made of anti-bacterial PVC.

The commonly accepted method of cladding sterile room walls with plastic panels includes the following steps: Adhesive is applied to the wall and the first plastic panel is applied. A second plastic panel is then applied to the wall, adjacent to the first, and so on. Since walls are often not perfectly straight and planar, spaces several millimeters wide may sometimes form between panels. Such gaps are made to “disappear” by soldering the edges of the panels using a soldering iron that heats the plastic and fuses together the edges of adjacent panels. Alternatively, adjacent panels may be joined using a plastic profile that is applied over the joint. This problem exists also when prefabricated gypsum walls are cladded with plastic panels at the factory before being installed at the work site.

The above mentioned methods all have several inherent problems. First, the soldering of the edges of the plastic panels requires a soldering expert since any mistake might result in the melting of a relatively large portion of the panel, which in turn requires dismantling of the damaged panel and its replacement with another panel.

Second, soldering causes the soldered part to slump, leading in turn to shrinkage and cracking, which besides detracting from the overall aesthetics of the room also constitutes a location for potential accumulation of dirt and bacteria. Second, the use of a profile to close the gaps between panels creates a joint that is not flush and it too constitutes a location of potential accumulation of dirt and bacteria. As a result, plastic panels are used only seldom as wall cladding in sterile rooms. The alternative to using plastic panels as wall cladding is to use stainless steel panels, artificial marble or HPL although their cost exceeds that of plastic panels by hundreds of percents.

The present invention offers a solution to the above described problems, presenting a system and method for cladding walls using plastic panels that is inexpensive, efficient and very easy to implement. The present invention also refers to unique adapters designed for use with standard saws required in order to implement the said method.

### DESCRIPTION OF THE DRAWINGS

The intention of the drawings attached to the application is not to limit the scope of the invention and its application.

The drawings are intended only to illustrate the invention and they constitute only one of its many possible implementations.

FIG. 1 depicts a connector (100) and a pair of plastic panels (300) with grooves (200).

FIG. 2 depicts a standard vertical power saw (400).

FIG. 3 depicts a standard horizontal power saw (500).

FIG. 4 depicts the adapter (1) mounted on a vertical power saw (400)

FIGS. 5 and 6 depict the adapter (1), which comprises a frame (11), protective plate (12), support plate (13), and fastening means (14).

FIGS. 7 and 8 depict the adapter (1) with an adjustable counter-support device (16).

FIG. 9 depicts the adapter (2) mounted on a horizontal power saw (500).

FIGS. 10 and 11 depict the adapter (2), which comprises a limiting device (21) and a horizontal support plate (22).

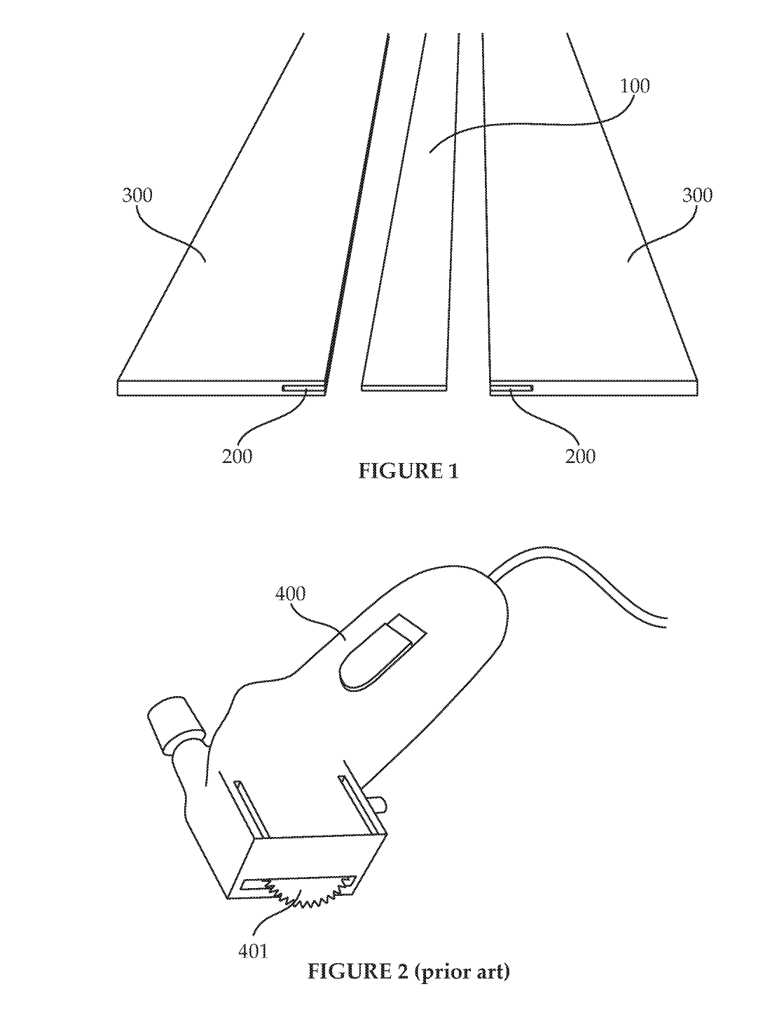

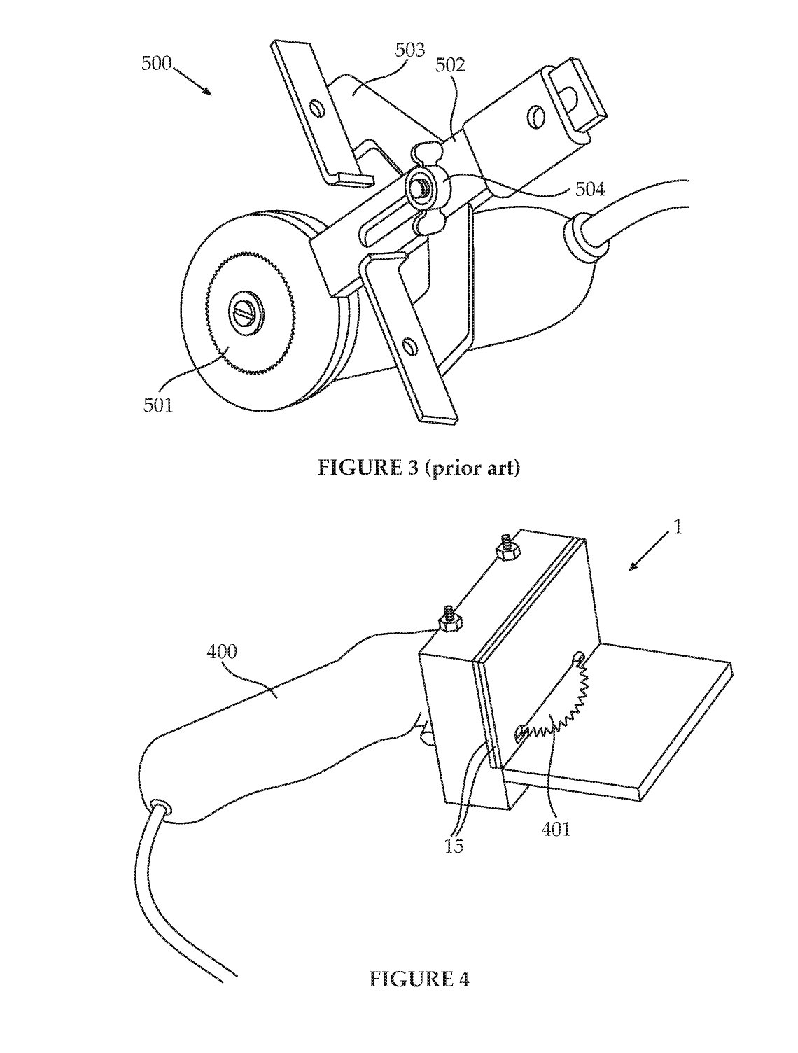

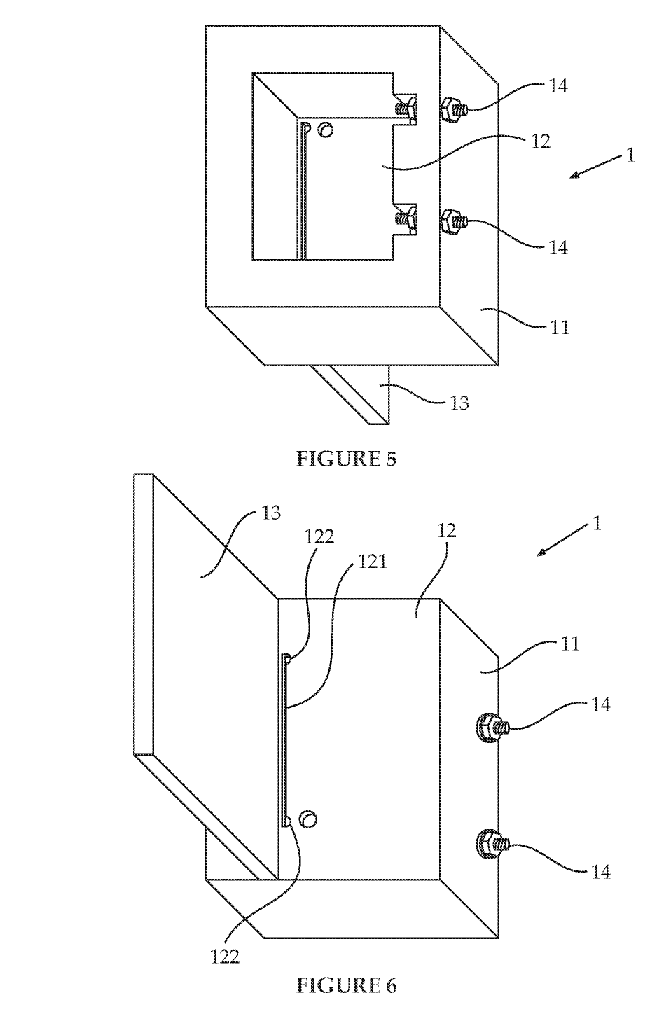

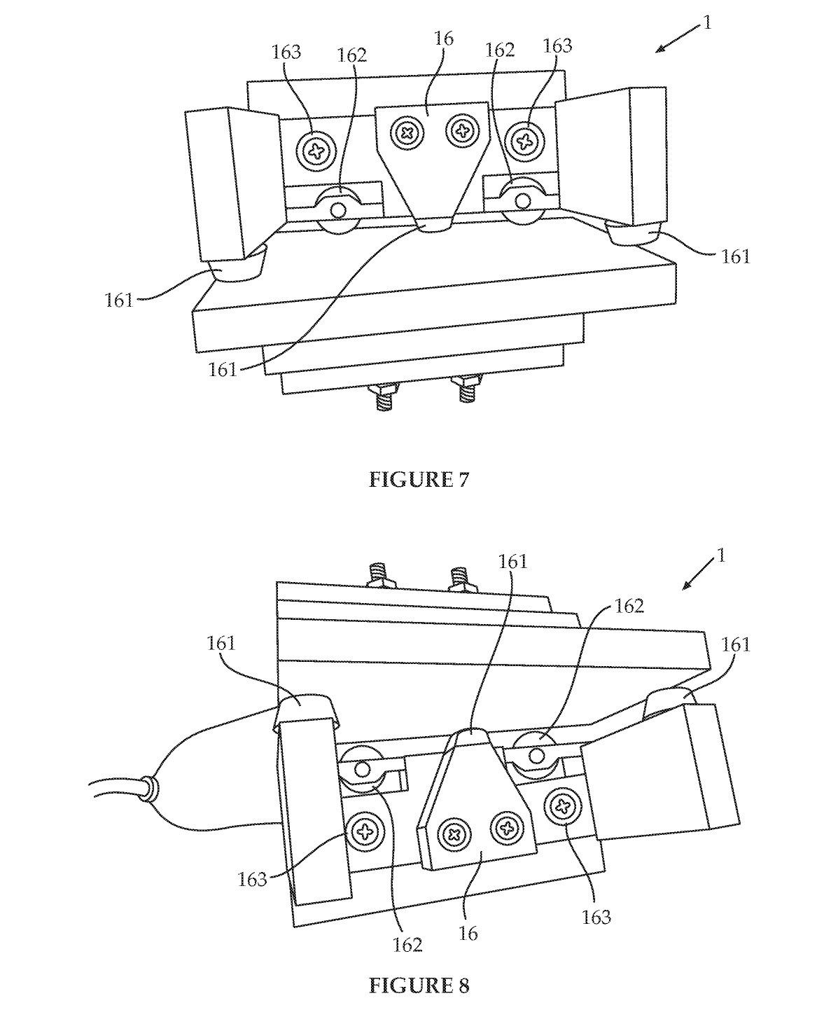

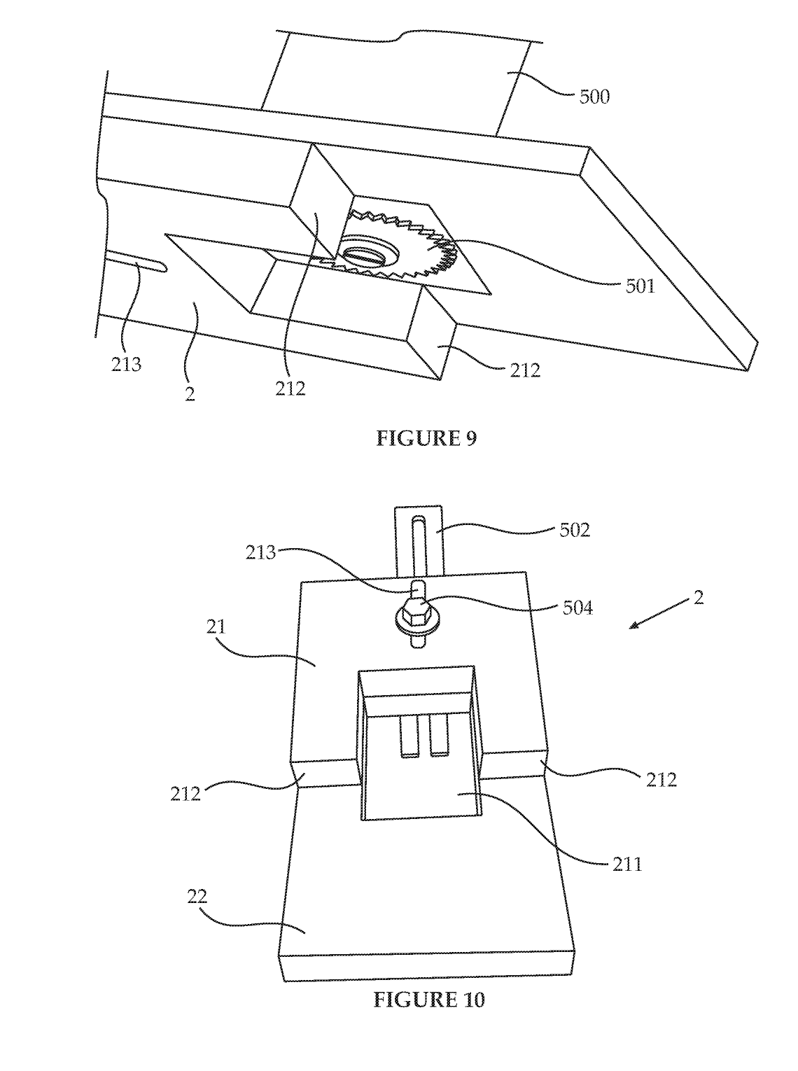

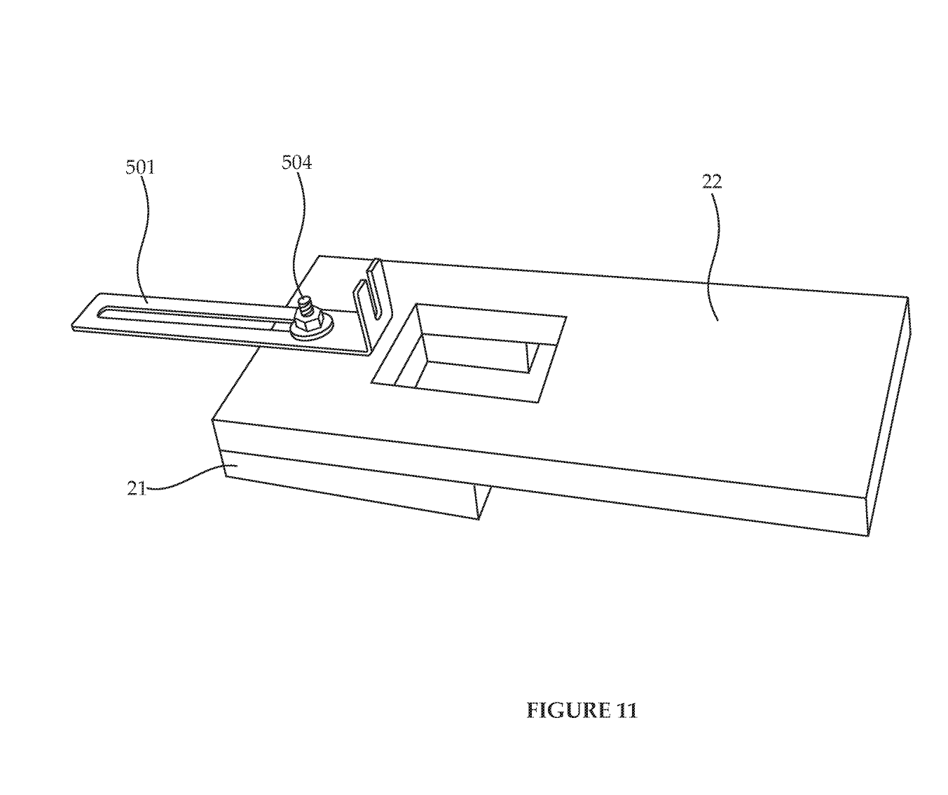

### THE INVENTION

The main objective of the present invention is to describe a method and system for cladding walls using plastic panels. Another objective of the present invention is to describe unique adapters for use with standard vertical and horizontal power saws that enable the user to execute relatively deep and narrow longitudinal grooves in the longitudinal sides of the plastic panels that are used in the implementation of the said method. Note that the term “power saws” refers to a wide variety of tools that can be used to cut or groove plastic panels.

The system and method, subject of the invention, are implemented using a connector (100) that is in general a long and narrow plastic strip, approximately 0.5 mm thick, 15 mm wide, and 300 cm long. The method and system include the following stages: (a) A narrow groove (200), approximately 0.5 mm wide and 7.5 mm deep, is executed in the longitudinal sides of the plastic panels (300). (b) One plastic panel (300) is applied to the wall using adhesive so that its longitudinal side is not adhered to the wall. (c) The connector (100) is inserted into the groove (200) of the plastic panel (300) that is already attached to the wall and into the groove (200) of another plastic panel (300) so that they become joined to one another via the connector (100). Before or after inserting the connector (100) into the grooves (200), adhesive or sealant is applied to the connector (100) or into the grooves (200). (d) The second plastic panel is then applied to the wall, and the process is repeated with additional plastic panels until the wall is cladded as desired. Drawing No. 1 depicts the connector (100) and a pair of plastic panels (300) with grooves (200).

Although we refer in the present application to plastic panels (300) that are 2 mm thick and to grooves (200) that are 0.5 mm thick and 7.5 mm deep, the dimensions specified in the present application are only the recommended dimensions and must obviously be adjusted to the dimensions of the plastic panels, the power saw, and in general to the user's specific needs.

Joining plastic panels (300) to one another using the said method and the connector (100) creates a clean, smooth, and straight joint with no gap or slump, and so the problems presented by the existing methods, as described above in the Introduction, are avoided. If any gap nevertheless remains, it is bound to be negligibly small. The adhesive used on the adapter or in the grooves must be a flexible and non-hardening adhesive.

The system and method as described above can be done also by using plastic panels (300) in lengths of 50 cm, more or less, and connectors (100) in lengths fit for the size of the plastic panels. Wherein the plastic panels are applied to the wall and then inserting the connectors (100) to the grooves (200) wherein the sealant functions also as a lubricant which make it easier to insert the connectors into the grooves.

The adapters (1) and (2), subject of the invention, are designed to enable the person executing the cladding works to execute the grooves (200) in the longitudinal sides of the plastic panels (300) at the work site, in a precise manner, and without damaging the plastic panels (300). This enables the user to execute grooves in panels that must be cut to length at the work site according to the dimensions of the room. The adapters (1) are also designed so as to enable the user to execute the grooves (200) using a standard power saw. One adapter (1) is designed for use with a vertical power saw (400), as depicted in Drawing No. 2, and a second adapter (2) is designed for use with a horizontal power saw (500), as depicted in Drawing No. 3.

Drawing No. 4 depicts the adapter (1), mounted on a vertical power saw (400) and Drawings Nos. 5 and 6 depict the adapter (1), which comprises a frame (11), a protective plate (12), a vertical support plate (13), and fastening means (14). All components of the adapter (1), except for the fastening means (14), can and should be made in one piece and from a rigid material such as metal, wood, or plastic.

The frame (11) is designed to fit over the vertical power saw (400) and to fix the adapter (1) to the saw (400). The specific design of the frame (11) should be compatible with the structure of the standard power saw used to implement the invention. The protective plate (12) has the general shape of a flat plate with a relatively long and narrow slit (121) through which the cutting disc (401) of the saw (400) is inserted in a perpendicular manner.

The vertical support plate (13) has the shape of a flat plate that is attached perpendicularly to the protective plate (12) so that when a groove (200) is made in the side of a plastic panel (300), the plastic panel (300) is held in place against the vertical support plate (13) so that a straight groove (200) is created. Since the plastic panel (300) is 2 mm thick and the saw disc (401) is 0.5 mm thick, the distance between the vertical support plate (13) and the side of the disc (401) closest to it should be approximately 0.75 mm.

The fastening means (14) are designed to tighten and fix the adapter (1) to the power saw (400). The fastening means (14) can be tightening screws as depicted in the drawings or one of a wide variety of fastening means such as springs, etc.

Vertical power saws (400) with an existing aperture to which a vacuum cleaner may be connected in order to vacuum waste shavings, may be connected to a vacuum cleaners so that the vacuum cleaner provides a flow of air in the direction of the disc (401) that cools the disc and prevents the heat generated when executing the groove (200) from melting the plastic panel (300). To enable air to flow in the direction of the disc (401), as mentioned, two vents (122) were added to the slit (121) in the protective plate (12).

Spacer plates (15): It is clear from the above explanation that the disc (401) protrudes from the protective plate (12) to an extent that corresponds to the depth of the groove (200), or in other words, approximately 7.5 mm. However, executing a groove that deep in a single step can cause the disc (401) to overheat and, in turn, to melt the plastic panel (300). In facilitate the execution of the groove (200) in several stages (for instance, in three steps each of which is 2.5 deep), spacer plates may be used. The spacer plates (15) are very thin, flat plates, about 2.5 mm thick, with a slit (1211) and vents (1221) that correspond in location to the slit (121) and vents (122) in the protective plate (12).

First, two spacers (15) are used to execute a groove (200) 2.5 mm deep. Then one spacer plate (15) is removed and the groove (200) is deepened by another 2.5 mm. Finally, the second spacer plate (15) is removed, and the groove (200) is deepened to the desired final depth.

Executing a groove (200) using the saw (400) with the adapter (1): The adapter (1) is mounted onto the power saw (400). The plastic panel (300) is placed on a workbench so that it protrudes slightly and the vertical support plate (12) is held closely against the plastic panel (300). The saw (400) is held closely against the side of the panel (300) and the groove (200) is executed. The precise structure of the adapter (1), and its angles and dimensions in particular, enable the user to execute a high-precision groove (200).

Drawings Nos. 7 and 8 depict another version of the adapter (1) whereby the adapter (1) is also equipped with an adjustable counter support device (16) designed to fix the plastic panel (300) to the vertical support plate (13) should the user wish to execute the groove (200) without using a workbench. The adjustable counter support device (16) has spacing protrusions (161) or spacing wheels (162) that prevent friction with the plastic panel (300) while the groove (200) is being executed. The adjustable counter support device (16) is also equipped with fastening means (163) designed to fix it to the plastic panel (300) while the groove (200) is being executed. The fastening devices (163) may be spring elements, tightening screws as depicted in the drawings, and so on.

Drawing No. 9 depicts the adapter (2) mounted on a horizontal power saw (500). We first describe the general structure of the standard horizontal power saw (500), depicted in Drawing No. 3. The horizontal saw (500) has a disc (501) and a mechanism designed to control the depth of cutting which comprises a track (502) and a limiting plate (503). The track (502) is attached to the body of the saw (500) and the limiting plate (503) is attached to the track (502) in a way that enables the user to adjust its position on the track (502) using the tightening screw (504). When using a horizontal saw (500), the user positions the limiting plate (503) on the track (502) according to the desired depth. The limiting plate (503) cannot, however, be used when the groove (200) is being executed since, among other things, it is not precise and exhibits small deviation and vibrations that are nevertheless significant when a small and precise cut is required.

The adapter (2), depicted in Drawings Nos. 10, comprises a limiting plate (21) and a horizontal support plate (22). The adapter's components can and should be made in one piece from a rigid material such as metal, wood or plastic. The limiting plate (21) has the general shape of a square with a cut-out (211) that creates a pair of frontal plates (212) that are perpendicular to the support plate. In addition, there is a slit (213) in the back part of the limiting plate (21). The general shape of the horizontal support plate (22) is of a flat plate.

The support plate (22) is attached to the limiting plate (21), which is attached to the track (502) by means of a tightening screw (504) that is inserted into the slit (213) so that the cut-out (211) flanks the disc (501), as depicted for instance in Drawing No. 9. When a plastic panel (300) is cut using a horizontal saw (500), the pair of frontal plates (212) limit and, in effect, defined the depth of the cut, which can be adjusted by loosening the tightening screw (504) and sliding the limiting plate (21) along the track (502) to the position that corresponds to the desired groove depth. This ability to control the depth of the groove (200) enables the user to execute the cut in several steps. The horizontal support plate (22) is attached to the limiting plate (21) so that the plastic panel (300) is supported during the cutting operation. The space between the bottom of the horizontal support plate (22) and the top of the disc (501) should be approximately 0.75 mm, according to the principle described in relation to the adapter (1).

Executing a groove (200) using the saw (500) with the adapter (2): The adapter (2) is mounted on the power saw (500) and the plastic panel (300) is placed on the workbench so that it protrudes slightly. The horizontal support plate (22) is held closely against the plastic panel (300), the saw is held closely against the side of the plastic panel (300), and the groove (200) is executed. The precise structure of the adapter (2), and its angles and dimensions in particular, enable the execution of a high-precision groove (200).

1-5 (canceled)

6. A method for cladding walls with plastic panels whose thickness ranges from 2 mm to 4 mm and for joining said plastic panels to one another during said cladding that comprises the following steps:
(a) providing said plastic panels and executing a groove in each of their longitudinal sides that is 0.4 mm to 0.6 mm wide and 5 mm to 15 mm deep;
(b) providing a connector with the general shape of a long and narrow strip;
(c) applying said plastic panels to wall using adhesive, while inserting said connectors into said grooves in said plastic panels;
applying adhesive sealant to said connectors or grooves before or after joining said panels to one another;
whereby the cladding of said walls with said plastic panels and the joining of said panels to one another results in clean, smooth, and straight joints.

7. An adapter for a standard vertical power saw equipped with a cutting disc designed to enable an execution of groove that are 0.4 mm to 0.6 mm wide in the longitudinal sides of plastic cladding panels that are 2 mm to 4 mm thick, wherein said adapter comprises a frame, a protective plate, a vertical support plate, and fastening means;
wherein said frame is designed to fit over said vertical power saw and be fixed to it;
wherein said protective plate has a slit through which said cutting disc of said standard vertical power saw is inserted in a perpendicular manner;
wherein said vertical support plate is shaped like a flat plate; wherein said vertical support plate is attached perpendicularly to said protective plate;
wherein said fastening means are designed to tighten and fix said adapter to said standard vertical power saw; wherein said adapter and said standard vertical power saw are fixed to one another at a permanent, fixed angle so that they move as an integral, single unit;
whereby said plastic cladding panel is held in place against said vertical support plate so that when executing said grooves in said longitudinal sides of said plastic cladding panels, straight grooves are created.

8. An adapter, as described in claim 2, that is further equipped with an adjustable counter support plate; wherein said counter support plate has spacing protrusions or spacing wheels; and wherein said counter support plate is designed to fix said plastic cladding panel to said vertical support plate when executing said groove.

9. An adapter for a standard horizontal power saw, which is equipped with a track and a cutting disc designed to execute grooves 0.4 mm to 0.6 mm wide in longitudinal sides of plastic cladding panels 2 mm to 4 mm thick, that comprises a limiting plate (21) and a horizontal support plate (22);
wherein said limiting plate (21) has a general shape of a square with a cut-out (211) that creates a pair of frontal plates (212); wherein the back part of said limiting plate (21) has a slit (213);
wherein said support plate (22) is attached onto said limiting plate (21); wherein said frontal plates (212) are perpendicular to said support plate (22);
wherein said limiting plate (21) is designed to be attached to said track (502) by means of a tightening screw (504) that is inserted into said slit (213) so that said cut-out (211) flanks said cutting disc (501);
wherein said track (502) is permanently attached to the body of said standard horizontal power saw (500); wherein said limiting plate (21) is attached to said track (502) in a way that enables a user to adjust its position along said track (502) using said tightening screw (504) and wherein said pair of frontal plates (212) limit and define the depth of said groove so as to obtain a groove of a desired depth.
